(19) United States
(12) Patent Application Publication
(10) Pub. No.: US 2004/0129273 A1
(43) Pub. Date: Jul. 8, 2004

(54) Bite block apparatus and method for use with a sedation and analgesia system

(75) Inventor: Randall S. Hickle, Lubbock, TX (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Scott Laboratories, Inc.

(21) Appl. No.: 10/677,494

(22) Filed: Oct. 3, 2003

Related U.S. Application Data
(60) Provisional application No. 60/415,521, filed on Oct. 3, 2002.

(51) Int. Cl. A62B 9/06

(52) U.S. Cl. 128/207.14

(57) ABSTRACT

The present invention provides a sedation and analgesia system having a bite block configured for integration and use with the system. The bite block facilitates access to the mouth while allowing the monitoring and delivery of gas via the oral and/or the nasal cavity where the monitoring and delivery are integrated with a sedation and analgesia system.

### CROSS REFERENCE TO RELATED APPLICATIONS

This application claims priority under 35 U.S.C. §119(e) to U.S. Provisional Patent Application No. 60/415,521, “Bite Block Apparatus and Method for Use with a Sedation and Analgesia System,” filed Oct. 3, 2002, which is hereby incorporated by reference.

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Field of the Invention

The present invention relates, in general, to endoscopic bite blocks and, more particularly, to endoscopic bite blocks used with sedation and analgesia systems.

2. Description of the Related Art

During endoscopic procedures, such as gastroscopy, it is necessary to insert medical instruments, such as tubes and scopes, into the mouth of a patient and down into the trachea. When endoscopic procedures are performed, a mouthpiece or “bite block,” is usually inserted into the patient's mouth to keep the mouth open and to prevent the patient from biting down on instrumentation passing through the block. Medical instruments, such as endoscopes, are then inserted through the opening in the bite block and down into the esophagus or trachea of the patient. While bite blocks capable of such functions are generally known in the art, these bite blocks are not structurally and functionally designed for use with a sedation and analgesia system.

A sedation and analgesia system may be used in a wide variety of medical applications, such as endoscopy, where the benefits of sedative, amnestic, and/or analgesic drug delivery are desirable. Sedation and analgesia systems may integrate patient monitoring, such as pulse oximeters and respiratory rate monitors, with a system of drug delivery. Such systems may further integrate the delivery of oxygen, where the delivery of gases and drugs is coordinated with monitored patient parameters to ensure patient safety. An example of such an integrated sedation and analgesia system is disclosed in U.S. patent application Ser. No. 09/324,759, filed Jun. 3, 1999 and incorporated herein by reference in its entirety.

In endoscopic procedures performed in cooperation with a sedation and analgesia system, bite blocks may be used that function independently of the sedation and analgesia system. It may be known, for example, to use an endoscopic mouthpiece to direct oxygen into the mouth of a patient. However, the operation of the mouthpiece is not integrated with patient monitoring and drug delivery of a sedation and analgesia system. The safety of patients who are part of medical procedures involving sedation and analgesia systems would be heightened if bite blocks used for those patients were integrated with and specifically tailored to the features and capabilities of sedation and analgesia systems.

### BRIEF SUMMARY OF THE INVENTION

The present invention comprises systems and methods for integrated sedation and analgesia that utilizes a bite block, which is integrated with and tailored to the features and capabilities specific to the integrated sedation and analgesia. In at least one embodiment, the present invention further comprises a plurality of gas sensors, where multiple sensors may provide added assurance that critical concentrations of gas are accurately monitored. In further embodiments of the present invention, gas outflow from a supply source to a patient is integrated with the bite block.

### BRIEF DESCRIPTION OF THE DRAWINGS

FIG. 1 illustrates a block diagram of one embodiment of a gas delivery and monitoring system integral with a sedation and analgesia system in accordance with the present invention;

FIG. 2 illustrates a schematic of one embodiment of a gas delivery and monitoring system in accordance with the present invention;

FIG. 3 illustrates a front view of one embodiment of a bite block in accordance with the present invention;

FIG. 4 illustrates one embodiment of an adapter for a bite block in accordance with the present invention;

FIG. 5 illustrates a top view of one embodiment of a bite block in accordance with the present invention;

FIG. 6 illustrates a perspective view of one embodiment of a nasal cannula attachment for a bite block in accordance with the present invention;

FIG. 7 illustrates a perspective view of an alternative embodiment of a nasal cannula attachment for a bite block in accordance with the present invention; and

FIG. 8 illustrates one embodiment of a method for using a bite block incorporated into a sedation and analgesia system in accordance with the present invention.

### DETAILED DESCRIPTION OF THE INVENTION

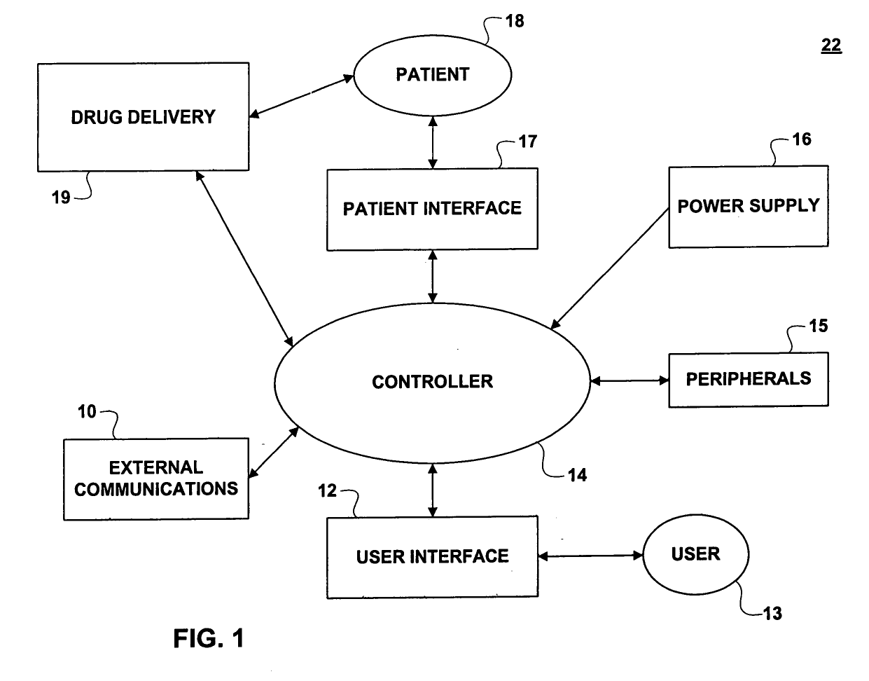

FIG. 1 illustrates a block diagram of one embodiment of a sedation and analgesia system 22 having user interface 12, software controlled controller 14, peripherals 15, power supply 16, gas monitoring and delivery system 9, external communications 10, patient interface 17, and drug delivery 19, where sedation and analgesia system 22 is operated by user 13 in order to provide sedation and/or analgesia to patient 18. An example of sedation and analgesia system 22 is disclosed and enabled by U.S. patent application Ser. No. 09/324,759, filed Jun. 3, 1999, which is herein incorporated by reference in its entirety. Examples of patient interface 17 are disclosed and enabled by U.S. patent application Ser. No. 09/592,943, filed Jul. 23, 2000 and incorporated herein by reference in its entirety.

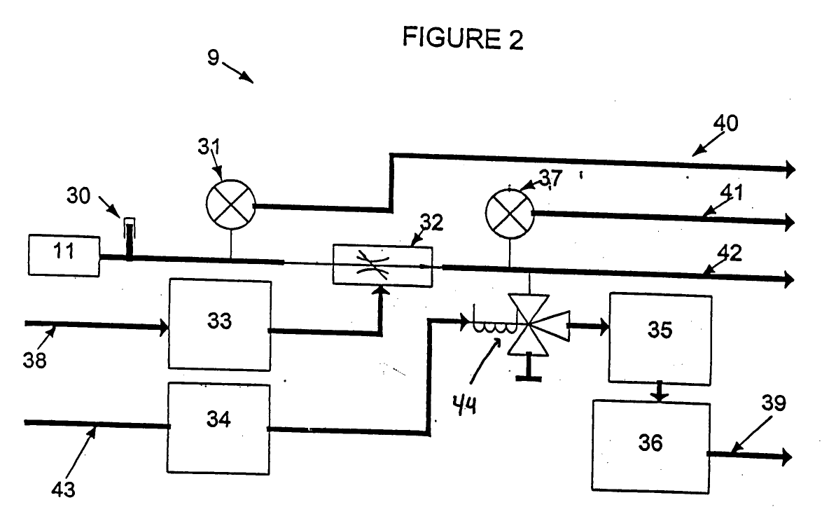

FIG. 2 illustrates a schematic depicting a more detailed view of one embodiment of gas monitoring and delivery system 9 and gas source 11 comprising pressure relief valve 30, high-side pressure sensor 31, high-side pressure output 40, variable size orifice valve 32, low-side pressure sensor 37, low-side pressure output 41, gas outflow 42, variable size orifice valve controller 33, variable size orifice valve control input 38, solenoid driver 34, control input 43 for sampling gas supplied to the patient, solenoid valve 44, gas sensor 35, gas sensor signal conditioner 36, and gas sensor output 39. Gas source 11 may be an in-house gas supply, a portable gas supply, or any other suitable gas dispenser. Gas source 11 further may provide containment and delivery of oxygen, nitrous oxide, sedatives, analgesics, other suitable gases, or any desirable combination of such.

Gas monitoring and delivery system 9 may be integrated with sedation and analgesia system 22. Pressure relief valve 30 may be any suitable pressure valve, such as model VRV-125B-N-75-X, made by Generant Company, where excessive gas pressure from gas source 11 will cause pressure relief valve 30 to purge gas resulting in decreased pressure. Pressure relief valve 30 may be located upstream from variable size orifice valve 32, downstream from variable size orifice valve 32, or both. Placing pressure relief valve 30 downstream will release gas pressure in the event that kinks or occlusions occur in tubing or hardware associated with gas monitoring and delivery system 9. Pressure relief valve 30 may be set to discharge gas at any threshold pressure such as, for example, 75 psi for upstream pressure relief and 25 psi for downstream pressure relief. Gas monitoring and delivery system 9 may also incorporate a pressure regulator (not shown) in combination with, or in place of, pressure relief valve 30. A further embodiment of the present invention comprises completely closing variable size orifice valve 32 in the event that high-side pressure sensor 31 and/or low-side pressure sensor 37 detect excessive gas pressure. High-side pressure sensor 31 and/or low-side pressure sensor 37 may communicate with controller 14, where if an excessive pressure threshold is met in either high-side pressure sensor 31 or low-side pressure sensor 37, controller 14 will completely close variable size orifice valve 32, thereby interrupting gas delivery to patient 18.

High-side pressure sensor 31 may be any suitable gas pressure sensor such as, for example, the XCAL4100GN, made by Honeywell, Inc. Low-Side pressure sensor 37 may be any suitable gas pressure sensor such as, for example, the XCAL430GN, made by Honeywell, Inc. Gas outflow 42 to patient 18, in one embodiment of the present invention, is controlled in an open loop fashion using variable size orifice valve 32. Changing the amount of current flowing through the valve coil (not shown) of variable size orifice valve 32 varies the flow orifice of variable size orifice valve 32. An excessive gas pressure event detected by high-side pressure sensor 31 or low-side gas pressure sensor 37 may be transmitted via high-side pressure output 40 or low-side pressure output 41, respectively, to controller 14. Controller 14 may communicate with variable size orifice valve controller 33 via variable size orifice control input 38. Variable size orifice valve controller 33 may alter the flow orifice of variable size orifice valve 32 by varying the current flow through the valve coil (not shown) as a result of communications received from controller 14. Varying the flow orifice of variable size orifice valve 32 causes changes in the magnitude of the outflow of gas to patient 18.

The present invention further comprises employing solenoid 44, solenoid driver 34, gas sensor 35, and gas sensor signal conditioner 36 to determine the concentration of, for example, O₂, in gas outflow 42. In one embodiment of the present invention, solenoid 44 is positioned downstream from variable size orifice valve 32. However, solenoid 44 may be positioned at any suitable location within gas monitoring and delivery system 9, including upstream of variable size orifice valve 32. The present invention comprises controller 14 signaling solenoid driver 34, via gas sample control input 43, to enable solenoid 44, thereby allowing a sample of gas to pass through solenoid 44 to gas sensor 35. Controller 14 may initiate solenoid driver 34 to enable solenoid 44 only during specified time periods. In one embodiment of the present invention, controller 14 signals solenoid driver 34 to enable solenoid 44 solely at the beginning of the medical procedure or as a result of oxygen desaturation. Testing gas 42 at the beginning of a medical procedure ensures that the proper gas and optionally the proper concentration of gas is connected to gas monitoring and delivery system 9. Enabling solenoid 44 only at specified periods may prolong the life of gas sensor 35 by reducing the average time of use of gas sensor 35 during procedures. Enabling solenoid 44 to allow gas sensor 35 to measure the concentration of gas 42 solely during critical monitoring periods may ensure patient safety while extending the useful life of gas sensor 35. The present invention comprises sampling the concentration of gas during initiation of gas monitoring and delivery system 9, in the event of a patient desaturation event, or at any other desirable time. The present invention may further comprise a manual feature, where user 13 may initiate a gas concentration measurement at any time during a medical procedure.

Gas sensor 35 may be a galvanic or fuel cell, a polarographic sensor, a paramagnetic sensor, or any other suitable gas sensor. The present invention further comprises a plurality of gas sensors 35, where multiple sensors may provide added assurance that critical concentrations of gas 42 are accurately monitored. Gas sensor signal conditioner 36 may be a signal amplifier, where the transmission from gas sensor 35 is amplified and routed through gas sensor signal conditioner 36. In one embodiment of the present invention, gas sensor signal conditioner 36 outputs gas percent or partial pressure output 39 to controller 14. Controller 14 may display information relative to gas concentrations in a visual display, such as that disclosed in U.S. patent application Ser. No. 10/285,689, filed Nov. 1, 2002, a data printout display, or in any other suitable means of informing user 13 of gas concentration. A further embodiment of the present invention comprises alerting user 13 of low gas concentration by a visual alarm, an audio alarm, or by other suitable alarms means.

Depending on the sensor type, the consumable components of the sensor may be gradually depleted by an oxidation reaction that is part of the measurement process. This oxidation reaction may continue even if solenoid 44 is closed and the sensor is not actively sampling outflow gas 42. The continued oxidation is fueled by the oxygen molecules trapped in the headspace between solenoid valve 44 and sensor 35. Therefore, to minimize continued oxidation from trapped O₂ molecules and maximize sensor life, the headspace accessible to the O₂ sensor may be designed as small as possible.

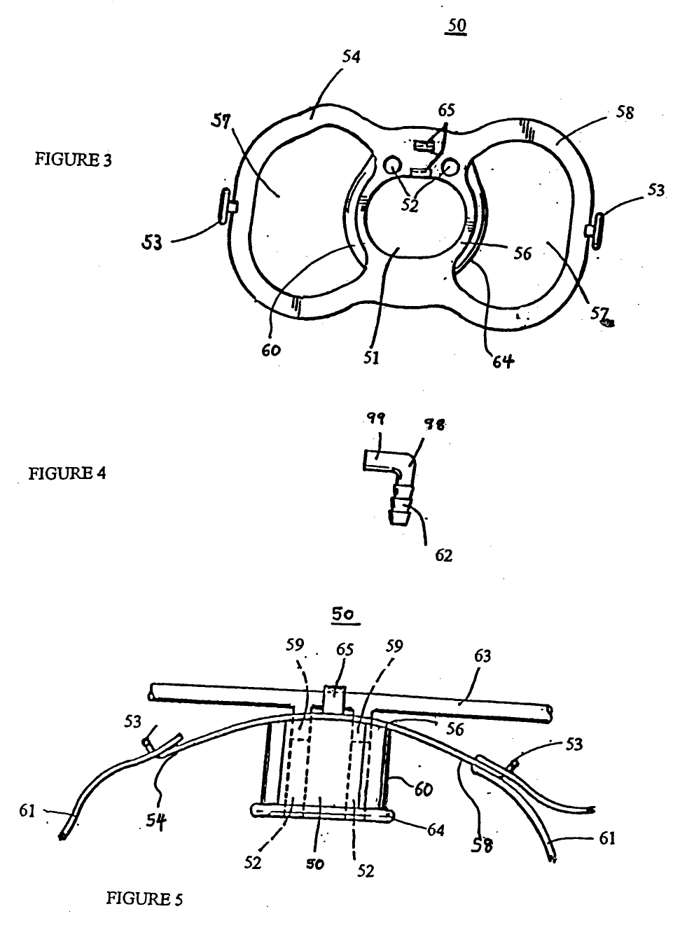

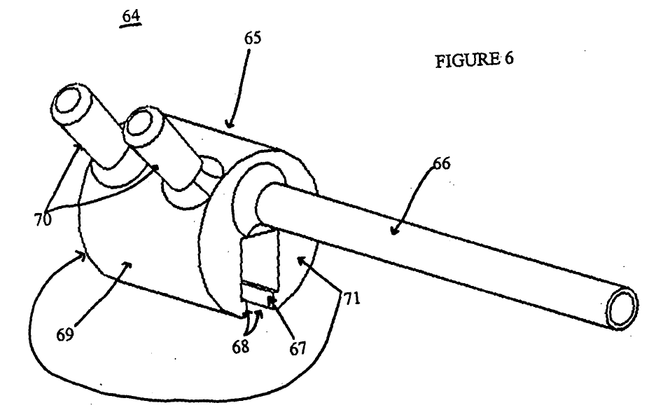

In one embodiment of the present invention, gas outflow 42 is integrated with bite block 50 (shown in FIGS. 3 and 5). Gas outflow 42 may flow through any suitable gas transfer means to bite block 50 such as, for example, oxygen supply tube 63 (shown in FIG. 5); however, the present invention comprises any suitable gas transfer means. The gas transfer means may be coupled with bite block 50 in any suitable way, as will be discussed further herein.

FIGS. 3 and 5 illustrate an embodiment of bite block 50 according to the present invention where FIG. 3 is a front view and FIG. 5 is a top view of bite block 50. Bite block 50 may be made from a flexible plastic material by injection molding or from any other suitable material and method of construction.

Bite block 50 further comprises an annular bite portion 60 which forms an opening 51. Bite portion 60 may be placed in a patient's mouth and serves to keep the mouth open during endoscopic procedures, while opening 51 permits medical instruments to be passed through the patient's mouth and into the esophagus or trachea. Bite portion 60 may be constructed with any suitable dimensions, where bite portion 60 may be enlarged for large scopes and tubes, divided into channels for multiple instruments, designed in multiple sizes for mouths of different sizes, and/or be designed in any other suitable configuration. The outer surface of bite portion 60 may be covered with an annular shaped compressible pad (not shown), such that a person biting the mouthpiece will make, preferably, a non-permanent impression into the compressible pad. The compressible pad may also include an adhesive surface, where the adhesive surface may limit the movement of bite block 50 within the patient's mouth. Bite portion 60 may increase the comfort of bite block 50 in conscious patients and may decrease the chances of dental or gum damage incurred when sedated or uncooperative patients bite down aggressively.

Still referring to FIGS. 3 and 5, bite block 50 may also comprise outer portion 56, which extends radially outwardly from one end of bite portion 60, so that when bite portion 60 is placed inside a patient's mouth, outer portion 56 remains outside the mouth and may cover all or a portion of the lips of the patient. Outer portion 56 may serve to limit movement of bite portion 60 further into the mouth. An inner rim 64 extends radially outwardly above the surface of the compressible pad at the other end of bite portion 60 and may be grasped by the tongue, teeth, or gums of the patient.

Bite block 50 also comprises one or more channels 52 that extend from the front surface of outer portion 56, through bite portion 60 and out through the back surface of inner rim 64. Channels 52 may be formed so that nasal cannulae 59 (shown in FIG. 5 only) can be inserted directly into channels 52 and then into the patient's mouth. Nasal cannulae 59 may extend from an oxygen supply tube 63 (shown in FIG. 5 only). Channels 52 may be used for any one or more of gas delivery, respiratory rate monitoring, oxygen concentration monitoring, positive and negative respiratory pressure monitoring, temperature monitoring, humidity monitoring, and respiratory flow monitoring. Sensors and/or sampling ports for the above monitoring may be placed into channels 52, where the sensors may be integrated with sedation and analgesia system 22 (FIG. 1) via leads. By placing such integrated sensors and/or sampling ports into bite block 50, sedation and analgesia system 22 may alter gas delivery through bite block 50 and/or drug delivery based on the patient's conditions as monitored by the sensors.

Bite block 50 may include a tube holder made up of curved fingers 65 for securing oxygen supply tube 63 to the surface of outer portion 56. In this manner, nasal cannulae 59 may be retained within channels 52. Curved fingers 65 may extend outwardly from outer portion 56 such that oxygen supply tube 63 can be snapped between curved fingers 65 and held against the surface of outer portion 56 while nasal cannulae 59 are located within channels 52.

Referring still to FIGS. 3 and 5, in order to keep bite block 50 stationary in a patient's mouth, bite block 50 may be secured to the head by use of an attachable elastic headstrap 61 (shown in FIG. 5 only). Headstrap 61 may be formed with openings (not shown) at the ends thereof, where one end of headstrap 61 is attached to T-shaped fasteners 53. Fasteners 53 are located on arms 54 and 58, which may extend laterally from the sides of outer portion 56. Headstrap 61 may be constructed from an elastic material such as, for example, latex, from material having hooks on one surface and a gripping surface on the opposing surface where the two surfaces may be interlocked, or from any other suitable material.

In an alternative embodiment of the present invention, bite block 50 does not include headstrap 61 and where inner rim 64 may be enlarged or otherwise configured to hold bite block 50 within the patient's mouth in the absence of headstrap 61.

In one embodiment of the present invention, arms 54 and 58 are semi-circular in shape and extend from the top of outer portion 56 to the bottom of outer portion 56. T-shaped fasteners 53 may be positioned at about the midpoint of arms 54 and 58 for insertion through headstrap 61 openings, for securing the ends of headstrap 61 to bite block 50. The present invention further provides any suitable connection and securing means for headstrap 61 such as, for example, by providing a locking clasp on arm 58, where headstrap 61 may be pulled through the clasp until the proper fit is achieved, whereupon the clasp may then be secured holding headstrap 61 in place.

Arms 54 and 58 may be formed so as to provide auxiliary openings 57 (shown in FIG. 3 only) between outer portion 56 and the ends of headstrap 61. This allows for the insertion of auxiliary instruments and fingers through openings 57 and into the mouth such that bite block 50 can be manipulated. Auxiliary openings 57 may be configured in a suitable way to provide easy access to bite block 50 and/or instrumentation passing through bite block 50.

Further embodiments of the present invention comprise a tongue depressor (not shown), that is an extension of bite portion 60, which extends beyond inner rim 64 into the patients mouth, where the tongue depressor holds down the patient's tongue and prevents them from using their tongue to push out the bite block.

FIG. 4 shows an attachable adapter 98 having a Luer taper 62 at one end that can be attached to oxygen supply tube 63 (FIG. 5) if nasal cannulae 59 (FIG. 5) are not used. Oxygen supply tube 63 may be formed with a corresponding Luer connector at one end for attachment to Luer taper 62 and the opposite end of oxygen supply tube 63 is connected to an oxygen supply integrated with sedation and analgesia system 22 (FIG. 1). The other end 99 of adapter 98 may be sized to be received in one of channels 52 (FIGs. may be adjustable to allow for proper positioning in the nose of the patient, and are preferably constructed from material that will not damage or cause significant pain to the nostrils of the patient.

Nasal cannula 64 further comprises a clip 67, where clip 67 may be used to attach nasal cannula 64 to any suitable bite block such as, for example, bite block 50 (FIGS. 3 and 5). Clip 67 includes clasping members 68, where clip 67 may substantially straddle outer surface 56 while being held firmly in place by clasping members 68 or any other suitable attachment mechanism. Once attached to the bite block, nasal cannula 64 may be used to record patient information and/or deliver gases, fluids, and/or drugs to the nasal orifices of the patient. Nasal cannula 64 may be permanently or detachably coupled to the bite block. Main body 65 may have any suitable shape such as, for example, a rectangular shape, that facilitates the secure attachment of nasal cannula 64 to the bite block and allows for chambers 70 to be successfully positioned within the patient's nostrils.

FIG. 7 illustrates an alternate embodiment of nasal cannula 64, where nasal cannula 64 includes rectangular main body 81, oral delivery chambers 78, nasal delivery chambers 76, and transmission tube 66. In one embodiment of the present invention, oral delivery chambers 78 are adapted for insertion into channels 52 (FIGS. 3 and 5). Chambers 78 may form a friction fit with channels 52 or may be held in place by any other suitable coupling means. Once oral delivery chambers 78 have been inserted into channels 52, nasal delivery chambers 76 will be positioned directly below the nostrils of the patient. Nasal delivery chambers 76 may include a telescoping feature that allows nasal delivery chambers 76 to be extended into the nostrils of the patient until a suitable fit is achieved. Nasal cannula 64 may be held in place by the coupling of oral delivery chambers 78 and channels 52, with a clip attachment to a bite block, and/or by any other suitable attachment means. Nasal cannula 64 allows for the simultaneous oral and nasal administration of fluids, gases, and/or drugs as delivered by transmission tube 76. Nasal cannula 64 may also be used for respiratory rate monitoring, respiratory pressure monitoring, flow monitoring, humidity monitoring, and/or temperature monitoring, where delivery and monitoring is controlled by sedation and analgesia system 22 (FIG. 1). The integration of a nasal cannula with a bite block may allow clinicians to monitor patients and deliver necessary gases, fluids, and/or drugs to patients nasally and orally while a bite block is in place. Patients may further benefit from the increased safety provided by integrating such systems with a sedation and analgesia system.

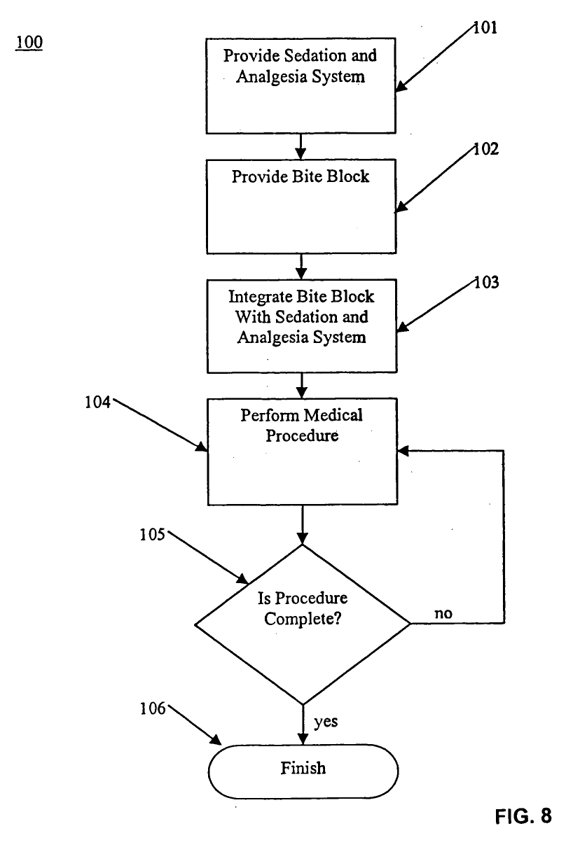

FIG. 8 illustrates one embodiment of method 100 in accordance with the present invention. Step 101 of method 100 comprises providing sedation and analgesia system 22 (FIG. 1). Step 102 comprises providing bite block 50 (FIGS. 3 and 5), where bite block 50 may be any suitable bite block having features and/or functionalities that may be integrated with sedation and analgesia system 22. Step 102 further comprises positioning bite block 50 on the patient.

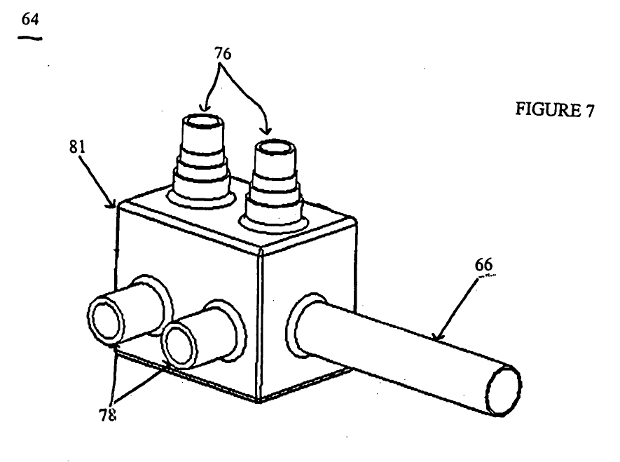

Step 103 of method 100 comprises integrating bite block 50 with sedation and analgesia system 22. Integrating bite block 50 with sedation and analgesia system 22 includes physically connecting electrical leads, gas delivery tubes, fluid delivery tubes, and/or other modes of transmission to sedation and analgesia system 22 and bite block 50. Bite block 50 further includes nasal cannula 64 (FIG. 6), where nasal cannula 64 may be permanently or detachably coupled to bite block 50. It is further contemplated that wireless sensors may be integrated with bite block 50, where step 103 may comprise ensuring that such wireless sensors or other transmission devices are in communication and integrated with sedation and analgesia system 22. Step 103 further comprises providing controller 14 (FIG. 1) with programming capable of comparing patient data received through bite block 50 with, for example, estimated normal patient parameters, where controller 14 may then alter or maintain gas delivery, fluid delivery, and/or drug delivery based on the comparative analysis. In one embodiment of the present invention, bite block 50 does not include sensors, where sedation and analgesia system 22 may vary gas delivery, fluid delivery, and/or drug delivery based on patient monitoring not directly incorporated into bite block 50. Delivery of gases, fluids, and/or drugs to bite block 50 may be automated, where sedation and analgesia system 22 takes immediate action based on patient condition; semi-automated, where sedation and analgesia system 22 makes decisions in cooperation with a qualified clinician; or manual, where the clinician may regard the information gathered by sedation and analgesia system 22 and control decisions impacting gas delivery, fluid delivery, drug delivery, and/or other operative functions. By integrating bite block 50 with sedation and analgesia system 22, the present invention incorporates the benefits of an integrated patient monitoring and drug delivery system with the benefits of oral and/or nasal access, monitoring, fluid delivery, gas delivery, and/or drug delivery. The present invention allows, for example, for oxygen to be delivered through bite block 50 at optimal rates and times due to the comprehensive patient monitoring associated with sedation and analgesia system 22.

Step 104 comprises performing the medical procedure involving sedation and analgesia system 22 integrated with bite block 50. In particular, bite block 50 may be used in endoscopy procedures where the benefits of conventional bite blocks may be combined with the benefits of an integrated sedation and analgesia system, however, bite block 50 integrated with sedation and analgesia system 22 may be used for any suitable medical procedure. During the medical procedure, method 100 may proceed to query 105.

Query 105 comprises ascertaining whether the medical procedure is complete. If the medical procedure is not complete, method 100 may loop back to step 104, where method 100 will continue to query 105 until a “yes” response is given to query 105. If a “yes” response is given to query 105, method 100 may proceed to finish 106 allowing for bite block 50 integrated with sedation and analgesia system 22 to be deactivated.

While exemplary embodiments of the invention have been shown and described herein, it will be obvious to those skilled in the art that such embodiments are provided by way of example only. Numerous insubstantial variations, changes, and substitutions will now be apparent to those skilled in the art without departing from the scope of the invention disclosed herein by the Applicants. Accordingly, it is intended that the invention be limited only by the spirit and scope of the claims as they will be allowed.

1. A sedation and analgesia system, comprising:
a patient health monitor device adapted so as to be coupled to a patient and generate a signal reflecting at least one physiological condition of the patient;
a drug delivery controller supplying one or more drugs to the patient;
a user interface;
a bite block comprising a bite portion and an opening to access the patient's mouth; and
an electronic controller interconnected with the patient health monitor, the user interface, and the drug delivery controller, wherein said electronic controller receives said signal and in response to said signal manages the application of the drugs.

2. The sedation and analgesia system of claim 1, wherein said bite block further comprises at least one channel extending through said bite portion.

3. The sedation and analgesia system of claim 2, wherein said at least one channel comprises at least one of a sensor and sampling port connected to a sensor for monitoring gases passing through said at least one channel.

4. The sedation and analgesia system of claim 3, wherein said at least one channel is used for at least one of respiratory rate monitoring, oxygen concentration monitoring, positive and negative respiratory pressure monitoring, temperature monitoring, humidity monitoring, and respiratory flow monitoring.

5. The sedation and analgesia system of claim 3, wherein said electronic controller alters said drug delivery based on said patient's conditions as monitored by said sensors.

6. The sedation and analgesia system of claim 2, wherein said at least one channel of said bite block provides an inlet for gas delivery.

7. The sedation and analgesia system of claim 6, further comprising a gas source and a gas monitoring and delivery system.

8. The sedation and analgesia system of claim 7, wherein said at least one channel is formed to hold a nasal cannula such that gas from said nasal cannula passes through said channel into said patient's mouth.

9. The sedation and analgesia system of claim 8, wherein said nasal cannula comprises both oral delivery chambers to connect to said bite block and nasal delivery chambers.

10. The sedation and analgesia system of claim 6, wherein said at least one channel comprises at least one of a sensor and sampling port connected to a sensor for monitoring gas output from said gas supply through said at least one channel.

11. The sedation and analgesia system of claim 10, wherein said electronic controller alters delivery of gas from said gas supply based on said patient's conditions as monitored by said sensors.

12. The sedation and analgesia system of claim 2, wherein said bite block further comprises a tongue depressor extending into the patients mouth, wherein the tongue depressor holds down the patient's tongue and prevents the patient from using their tongue to push out the bite block.

13. A sedation and analgesia system, comprising:
a patient health monitor device adapted so as to be coupled to a patient and generate a signal reflecting at least one physiological condition of the patient;
a drug delivery controller supplying one or more drugs to the patient;
a user interface;
a gas monitoring and delivery system supplying one or more types of gas to the patient;
a bite block comprising a bite portion, an opening, and at least one channel; and
an electronic controller interconnected with the patient health monitor, the user interface, the gas monitoring and delivery system, and the drug delivery controller, wherein said electronic controller receives said signal and in response to said signal manages the application of at least one of the drugs and the gas.

14. The sedation and analgesia system of claim 13, wherein said at least one channel comprises at least one of a sensor and sampling port connected to a sensor for monitoring gases passing through said at least one channel.

15. The sedation and analgesia system of claim 14, wherein said sensors are wirelessly integrated with said electronic controller.

16. The sedation and analgesia system of claim 14, wherein said electronic controller alters delivery of gas from said gas supply based on said patient's conditions as monitored by said sensors.

17. The sedation and analgesia system of claim 16, wherein said bite block further comprises a tongue depressor extending into the patients mouth, wherein the tongue depressor prevents the patient from using their tongue to push out the bite block.

18. The sedation and analgesia system of claim 12, wherein said bite block is integrated with a nasal cannula such that at least one of gases, fluids, and drugs can be delivered to said patient both nasally and orally.

19. A method for using a bite block incorporated into a sedation and analgesia system comprising the steps of:
providing sedation and analgesia system;
providing bite block with functionalities that can be integrated with said sedation and analgesia system;
integrating bite block with sedation and analgesia system;
providing said sedation and analgesia system with programming capable of comparing patient data received through the bite block estimated normal patient parameters, wherein a controller may then adjust at least one of gas delivery, fluid delivery, and drug delivery based on comparative analysis of said normal parameters and said patient data; and
performing a medical procedure involving said sedation and analgesia system integrated with said bite block.

20. The method of claim 19, wherein said step of integrating comprises at least one of physically connecting one or more electrical leads, gas delivery tubes, fluid delivery tubes, and nasal cannula and ensuring communication with wireless sensors.
